(19) United States
(12) Patent Application Publication
(10) Pub. No.: US 2026/0004719 A1
(43) Pub. Date: Jan. 1, 2026

(54) DISPLAY DEVICE AND METHOD OF DRIVING THE SAME, AND ELECTRONIC DEVICE

(71) Applicant: Samsung Display Co., Ltd., Yongin-si (KR)

(72) Inventors: Ki Hyun PYUN, Yongin-si (KR); Jung Eon AN, Yongin-si (KR)

(21) Appl. No.: 19/210,700

(22) Filed: May 16, 2025

(30) Foreign Application Priority Data
Jun. 26, 2024 (KR) 10-2024-0083792

(51) Int. Cl. G09G 3/32; G09G 3/3233

(52) U.S. Cl. CPC G09G 3/32; G09G 3/3233; G09G 2300/043; G09G 2310/08; G09G 2320/0257; G09G 2320/0285; G09G 2330/023; G09G 2330/028

(57) ABSTRACT

A display device includes a display including pixels connected to a first power line, a second power line, scan lines, and data lines, a current sensor for sensing a global current value flowing to the pixels, a power generator for supplying a first driving power and a second driving power to the first and second power lines, and a timing controller for controlling the power generator so that a voltage rising time of the first driving power is changed in response to a differential voltage value corresponding to a difference between a voltage of the first driving power of a previous frame and a voltage of the first driving power of a current frame, and in response to a differential current value corresponding to a difference between the global current value and a maximum current value to flow to the pixels in response to a load of the display.

### CROSS-REFERENCE TO RELATED PATENT APPLICATION

The present application claims priority to, and the benefit of, Korean Patent Application Number 10-2024-0083792 filed on Jun. 26, 2024, in the Korean Intellectual Property Office, the entire disclosure of which is incorporated herein by reference.

### BACKGROUND

### 1. Field

Embodiments of the present disclosure relate to a display device, a method of driving the same, and an electronic device.

### 2. Description of the Related Art

With the development of information technology, the importance of display devices as a connecting medium between users and information is increasing. In response, the use of display devices such as liquid crystal display devices and organic light-emitting display devices is increasing.

The display device includes pixels. The pixels may display an image (e.g., a predetermined image) by emitting light of a brightness (e.g., a predetermined brightness) in response to a driving current flowing from a first driving power to a second driving power via a light-emitting element.

The voltage value of the first driving power may be changed in response to a load and peak grayscale of a display (or a display panel). For example, the voltage value of the first driving power of the p frame may be determined corresponding to the load and peak grayscale of the display of the p−1 frame (where p is a natural number of 1 or more). If the voltage of the first driving power of the current frame is determined by the load and peak grayscale of the display of the previous frame (or, if the voltage of the first driving power is reflected with a delay by one frame unit), there is a concern that the driving current may exceed the limit current value or the power consumption may exceed the power specification (e.g., a preset power specification).

### SUMMARY

One aspect of the present disclosure is to provide a display device capable of ensuring driving stability and a method of driving the same, and an electronic device.

A display device according to embodiments of the present disclosure includes a display including pixels connected to a first power line, to a second power line, to scan lines, and to data lines, a current sensor for sensing a global current value flowing to the pixels, a power generator for supplying a first driving power to the first power line, and a second driving power to the second power line, and a timing controller for controlling the power generator so that a voltage rising time of the first driving power is changed in response to a differential voltage value corresponding to a difference between a voltage of the first driving power of a previous frame and a voltage of the first driving power of a current frame, and in response to a differential current value corresponding to a difference between the global current value and a maximum current value to flow to the pixels in response to a load of the display.

The timing controller may be configured to control the power generator so that the voltage of the first driving power is risen in a step-wave form in response to the differential voltage value having a value that is greater than or equal to a first threshold value and the differential current value having a value that is greater than or equal to a second threshold value.

The display device may further include a sensing resistor between the first power line and the display, and connected to the current sensor to enable sensing of the global current value.

The timing controller may include an analyzer for analyzing peak grayscale and the load on a frame basis using input data, a voltage determiner for determining a voltage value of the first driving power on the frame basis in response to the peak grayscale and the load, a voltage comparer for receiving the voltage of the first driving power of the previous frame and the voltage of the first driving power of the current frame from the voltage determiner to generate the differential voltage value, a current comparer for generating the differential current value by comparing the maximum current value with the global current value, a voltage controller for generating an enable signal based on the differential voltage value and the differential current value, and a code value generator configured to generate a voltage code so that the voltage of the first driving power is risen stepwise in response to the enable signal.

The power generator may be configured to generate the first driving power in response to the voltage code.

The display device may further include a memory including a first lookup table for storing a threshold voltage value corresponding to the load, a second lookup table for storing a threshold current value corresponding to the load, a third lookup table for storing the maximum current value corresponding to the load, and a fourth lookup table for storing time/voltage information including time information at which the first driving power is risen, and voltage information at which the first driving power is risen.

The threshold voltage value may be configured to increase as the load increases.

The threshold current value may be configured to increase as the load increases.

The maximum current value may be configured to increase as the load increases.

The code value generator may be configured to generate the voltage code so that the voltage of the first driving power is risen stepwise by a voltage for respective time periods in response to the enable signal.

The voltage controller may be configured to generate the enable signal in response to the differential voltage value exceeding the threshold voltage value corresponding to the load, and the differential current value exceeding the threshold current value corresponding to the load.

The code value generator may be configured to rise the voltage of the first driving power to a voltage corresponding to the current frame when the enable signal is not input.

A method of driving a display device including pixels configured to emit light in response to an amount of current flowing from a first driving power to a second driving power via a light-emitting element according to one or more embodiments includes generating a differential voltage value between a first voltage of the first driving power of a current frame and a second voltage of the first driving power of a previous frame, generating a differential current value between a maximum current value to flow to a display in response to a load of the display and an actual current flowing to the display, and controlling a rising time of the first driving power in response to the differential voltage value and the differential current value.

The controlling of the rising time of the first driving power may include comparing the differential voltage value with a threshold voltage value corresponding to the load, comparing the differential current value with a threshold current value corresponding to the load, and controlling a voltage of the first driving power to be risen stepwise to the first voltage in response to the differential voltage value being greater than the threshold voltage value and the differential current value being greater than the threshold current value.

The controlling of the rising time of the first driving power may include rising the voltage of the first driving power to the first voltage in response to the differential voltage value being less than the threshold voltage value or the differential current value being less than the threshold current value.

The method may further include increasing the threshold voltage value as the load increases.

The method may further include increasing the threshold current value as the load increases.

The method may further include rising the voltage of the first driving power stepwise such that the voltage of the first driving power rises by a voltage amount at respective time periods.

An electronic device according to one or more embodiments of the present disclosure includes a display panel including pixels configured to receive a driving current from a first driving power, a voltage generation circuit configured to generate the first driving power, and a controller configured to control a rising time of the first driving power in response to a differential voltage value corresponding to a difference between a voltage of the first driving power of a current frame and a voltage of the first driving power of a previous frame and in response to a differential current value corresponding to a difference between a maximum current value to flow to the display panel in response to a load and a current actually flowing to the display panel.

The controller may be configured to control the voltage generation circuit so that the first driving power is risen stepwise in response to the differential voltage value being greater than a first threshold value and the differential current value being greater than a second threshold value.

The electronic device may include a smartphone, a television, a monitor, a tablet, an electric vehicle, a mobile phone, a tablet personal computer (PC), a mobile communication terminal, an electronic notebook, an electronic book, a portable multimedia player (PMP), a navigation device, an ultra-mobile PC (UMPC), a laptop computer, a billboard, an Internet of Things (IoT) device, a smartwatch, a watch phone, or a head-mounted display (HMD).

Aspects of the present disclosure are not limited to the objects mentioned above, and other aspects not mentioned will be clearly understood by those skilled in the art from the description below.

According to a display device and a method of driving the same, and an electronic device according to embodiments of the present disclosure, when a voltage difference between frames is relatively large or a difference between an actual amount of current to flow and a sensed amount of current is large, voltage of a first driving power may be risen stepwise. When the voltage of the first driving power is risen stepwise, the driving current and power consumption may also be risen stepwise, thereby ensuring driving stability.

However, effects of the present disclosure are not limited to the effects described above, and may be expanded in various ways without departing from the spirit and scope of the present disclosure.

### BRIEF DESCRIPTION OF THE DRAWINGS

FIG. 1 is a diagram illustrating a display device according to one or more embodiments of the present disclosure.

FIG. 2 is a diagram illustrating one or more embodiments of a pixel illustrated in FIG. 1.

FIGS. 3A to 3C are diagrams illustrating driving current and power consumption when a voltage of a first driving power is reflected with a delay of one frame.

FIG. 4 is a diagram illustrating a timing controller and a power generator according to one or more embodiments of the present disclosure.

FIG. 5 is a diagram illustrating one or more embodiments of a memory illustrated in FIG. 4.

FIGS. 6A and 6B are diagrams for explaining a threshold voltage value.

FIGS. 7A and 7B are diagrams for explaining a threshold current value.

FIGS. 8A, 8B, 9A, and 9B are diagrams illustrating an operation process of a voltage controller.

FIG. 10 is a diagram illustrating an operation process of a code value generator.

FIGS. 11A to 11C are diagrams illustrating driving current and power consumption when a voltage of a first driving power is reflected with a delay of one frame according to one or more embodiments of the present disclosure.

FIG. 12 is a diagram illustrating an electronic device according to one or more embodiments of the present disclosure.

### DETAILED DESCRIPTION

Aspects of some embodiments of the present disclosure and methods of accomplishing the same may be understood more readily by reference to the detailed description of embodiments and the accompanying drawings. The described embodiments are provided as examples so that this disclosure will be thorough and complete, and will fully convey the aspects of the present disclosure to those skilled in the art. Accordingly, processes, elements, and techniques that are redundant, that are unrelated or irrelevant to the description of the embodiments, or that are not necessary to those having ordinary skill in the art for a complete understanding of the aspects of the present disclosure may be omitted. Unless otherwise noted, like reference numerals, characters, or combinations thereof denote like elements throughout the attached drawings and the written description, and thus, repeated descriptions thereof may be omitted.

The described embodiments may have various modifications and may be embodied in different forms, and should not be construed as being limited to only the illustrated embodiments herein. The use of “can,” “may,” or “may not” in describing an embodiment corresponds to one or more embodiments of the present disclosure.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

In the drawings, the relative sizes of elements, layers, and regions may be exaggerated for clarity and/or descriptive purposes. In other words, because the sizes of elements in the drawings are arbitrarily illustrated for convenience of description, the disclosure is not limited thereto.

It will be understood that when an element, layer, region, or component (e.g., an apparatus, a device, a circuit, a wire, an electrode, a terminal, a conductive film, etc.) is referred to as being “formed on,” “on,” “connected to,” or “(operatively, functionally, or communicatively) coupled to” another element, layer, region, or component, it can be directly formed on, on, connected to, or coupled to the other element, layer, region, or component, or indirectly formed on, on, connected to, or coupled to the other element, layer, region, or component such that one or more intervening elements, layers, regions, or components may be present. In addition, this may collectively mean a direct or indirect coupling or connection and an integral or non-integral coupling or connection. For example, when a layer, region, or component is referred to as being “electrically connected” or “electrically coupled” to another layer, region, or component, it can be directly electrically connected or coupled to the other layer, region, and/or component or one or more intervening layers, regions, or components may be present. The one or more intervening components may include a switch, a transistor, a resistor, an inductor, a capacitor, a diode and/or the like. Accordingly, a connection is not limited to the connections illustrated in the drawings or the detailed description and may also include other types of connections.

In describing embodiments, an expression of connection indicates electrical connection unless explicitly described to be direct connection, and “directly connected/directly coupled,” or “directly on,” refers to one component directly connecting or coupling another component, or being on another component, without an intermediate component. Meanwhile, other expressions describing relationships between components, such as “between,” “immediately between” or “adjacent to” and “directly adjacent to,” may be construed similarly. It will be understood that when an element or layer is referred to as being “between” two elements or layers, it can be the only element or layer between the two elements or layers, or one or more intervening elements or layers may also be present.

For the purposes of this disclosure, expressions such as “at least one of,” or “any one of,” or “one or more of” when preceding a list of elements, modify the entire list of elements and do not modify the individual elements of the list. For example, “at least one of X, Y, and Z,” “at least one of X, Y, or Z,” “at least one selected from the group consisting of X, Y, and Z,” and “at least one selected from the group consisting of X, Y, or Z” may be construed as X only, Y only, Z only, any combination of two or more of X, Y, and Z, such as, for instance, XYZ, XYY, YZ, and ZZ, or any variation thereof. Similarly, the expressions “at least one of A and B” and “at least one of A or B” may include A, B, or A and B. As used herein, “or” generally means “and/or,” and the term “and/or” includes any and all combinations of one or more of the associated listed items. For example, the expression “A and/or B” may include A, B, or A and B. Similarly, expressions such as “at least one of,” “a plurality of,” “one of,” and other prepositional phrases, when preceding a list of elements, modify the entire list of elements and do not modify the individual elements of the list. When “C to D” is stated, it means C or more and D or less, unless otherwise specified.

It will be understood that, although the terms “first,” “second,” “third,” etc., may be used herein to describe various elements, components, regions, layers and/or sections, these elements, components, regions, layers and/or sections should not be limited by these terms. These terms do not correspond to a particular order, position, or superiority, and are used only used to distinguish one element, member, component, region, area, layer, section, or portion from another element, member, component, region, area, layer, section, or portion. Thus, a first element, component, region, layer or section described below could be termed a second element, component, region, layer or section, without departing from the spirit and scope of the present disclosure. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-category (or first-set),” “second-category (or second-set),” etc., respectively.

The terminology used herein is for the purpose of describing embodiments only and is not intended to be limiting of the present disclosure. As used herein, the singular forms “a” and “an” are intended to include the plural forms as well, while the plural forms are also intended to include the singular forms, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

As used herein, the terms “substantially,” “about,” “approximately,” and similar terms are used as terms of approximation and not as terms of degree, and are intended to account for the inherent deviations in measured or calculated values that would be recognized by those of ordinary skill in the art. For example, “substantially” may include a range of +/−5% of a corresponding value. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value. Further, the use of “may” when describing embodiments of the present disclosure refers to “one or more embodiments of the present disclosure.” Furthermore, the expression “being the same” may mean “being substantially the same”. In other words, the expression “being the same” may include a range that can be tolerated by those of ordinary skill in the art. The other expressions may also be expressions from which “substantially” has been omitted.

In some embodiments well-known structures and devices may be described in the accompanying drawings in relation to one or more functional blocks (e.g., block diagrams), units, and/or modules to avoid unnecessarily obscuring various embodiments. Those skilled in the art will understand that such block, unit, and/or module are/is physically implemented by a logic circuit, an individual component, a microprocessor, a hard wire circuit, a memory element, a line connection, and other electronic circuits. This may be formed using a semiconductor-based manufacturing technique or other manufacturing techniques. The block, unit, and/or module implemented by a microprocessor or other similar hardware may be programmed and controlled using software to perform various functions discussed herein, optionally may be driven by firmware and/or software. In addition, each block, unit, and/or module may be implemented by dedicated hardware, or a combination of dedicated hardware that performs some functions and a processor (for example, one or more programmed microprocessors and related circuits) that performs a function different from those of the dedicated hardware. In addition, in some embodiments, the block, unit, and/or module may be physically separated into two or more interact individual blocks, units, and/or modules without departing from the scope of the present disclosure. In addition, in some embodiments, the block, unit and/or module may be physically combined into more complex blocks, units, and/or modules without departing from the scope of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

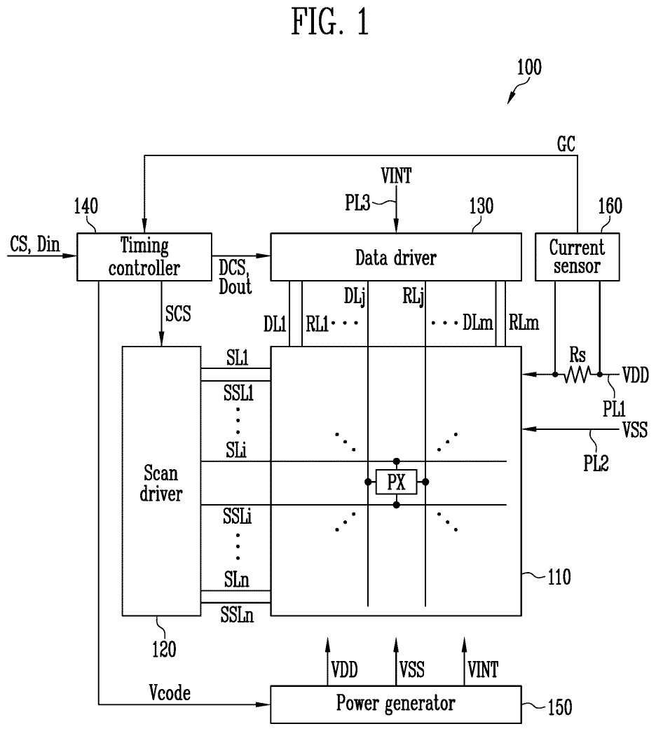

FIG. 1 is a diagram illustrating a display device according to one or more embodiments of the present disclosure.

Referring to FIG. 1, a display device 100 according to one or more embodiments of the present disclosure may include a display 110 (or display panel), a scan driver 120, a data driver 130, a timing controller 140, a power generator 150, and a current sensor 160. The scan driver 120, the data driver 130, the timing controller 140, the power generator 150, and the current sensor 160 may form a driving device that drives the display 110.

The display 110 may display an image. The display 110 may be provided with pixels (PX) connected to first scan lines (SL1, . . . , SLi, . . . , SLn), second scan lines (SSL1, . . . , SSLi, . . . , SSLn), data lines (DL1, . . . , DLj, . . . , DLm), and read-out lines (RL1, . . . , RLj, . . . , RLm) (where n and m are natural numbers of 3 or more, i is a natural number of n or less and 1 or more, and j is a natural number of m or less and 1 or more).

The pixel (PX) may be connected to one of the first scan lines (SL1 to SLn) and to one of the data lines (DL1 to DLm). In addition, the pixel (PX) may be connected to one of the second scan lines (SSL1 to SSLn) and to one of the read-out lines (RL1 to RLm).

For example, a pixel (PX) located in the i^{th} row and the j^{th} column, may be connected to the i^{th} first scan line (SLi), the i^{th} second scan line (SSLi), the j^{th} data line (DLj), and the j^{th} read-out line (RLj). In addition, the pixel (PX) may be connected to a first power line (PL1) to which a first driving power (VDD) is applied, and a second power line (PL2) to which a second driving power (VSS) is applied.

The first driving power (VDD) may be a power that supplies a driving current to the pixel (PX), and the second driving power (VSS) may be a power that receives a driving current from the pixel (PX). During the light emission period of the pixel (PX), the first driving power (VDD) may be set to a higher voltage than the second driving power (VSS).

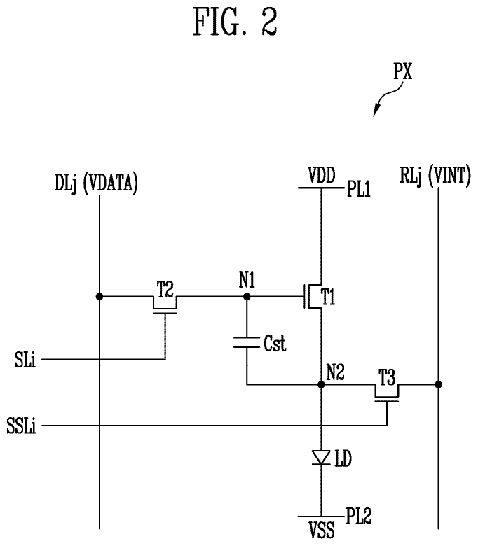

The pixel (PX) may be initialized by an initialization power (VINT) provided through the read-out line (RLj) in response to a second scan signal provided through the second scan line (SSLi), and may be supplied with a data signal (or data voltage) through the data line (DLj) in response to a first scan signal provided through the first scan line (SLi). The pixel (PX) may generate light with a brightness corresponding to the data signal by controlling the amount of current flowing from the first driving power (VDD) to the second driving power (VSS) via a light-emitting element (LD) (see FIG. 2) in response to the data signal. The initialization power (VINT) can be set to a voltage that is lower than an operating point (or threshold voltage) of the light-emitting element (LD).

The scan driver 120 may generate a first scan signal and a second scan signal based on a scan control signal (SCS). The first scan signal may be sequentially supplied to the first scan lines (SL1 to SLn), and the second scan signal may be sequentially supplied to the second scan lines (SSL1 to SSLn).

The scan control signal (SCS) may include a start signal and a clock signal, and may be provided from the timing controller 140 to the scan driver 120. The scan driver 120 may be implemented as a shift register that sequentially shifts the start signal in response to the clock signal to sequentially generate and output the first scan signal in a pulse form. In addition, the scan driver 120 may generate and output the second scan signal similarly to the manner in which the first scan signal is generated. The scan driver 120 may include a first scan driver for generating the first scan signal, and a second scan driver for generating the second scan signal.

The scan driver 120 may be formed together with a pixel (PX) on the display 110. However, the present disclosure is not limited thereto, and for example, the scan driver 120 may be mounted on a circuit film, and may be connected to the timing controller 140 via at least one circuit film and a printed circuit board.

The data driver 130 may generate the data signal (or data voltage) based on output data (Dout) and a data control signal (DCS) provided from the timing controller 140, and may provide the data signal to the display 110 (or pixel (PX)) via data lines (DL1 to DLm). Here, the data control signal (DCS) may include a data enable signal, a data clock signal, etc. The data driver 130 may provide the initialization power (VINT) to the display 110 (or the pixel (PX)) through the read-out lines (RL1 to RLm).

In one or more embodiments, the data driver 130 may receive a sensing signal through the read-out lines (RL1 to RLm) in a separate sensing section (for example, in a sensing section allocated for sensing characteristic information of the pixel (PX), such as the threshold voltage and/or mobility of a driving transistor included in the pixel (PX)). The sensing signal can be used to compensate for the characteristics (or characteristic deviation) of the pixel (PX) in the data driver 130 and/or the timing controller 140.

In one or more embodiments, the read-out lines (RL1 to RLm) may be connected to a separate sensor. In this case, the voltage of the initialization power (VINT) may be supplied from the sensor to the display 110, or the sensing signal may be received through the read-out lines (RL1 to RLm).

The power generator 150 may supply the first driving power (VDD) and the second driving power (VSS) to the display 110. The power generator 150 may supply the initialization power (VINT) to the data driver 130.

The power generator 150 may generate the first driving power (VDD) having a voltage (e.g., a predetermined voltage) corresponding to a voltage code (Vcode) supplied from the timing controller 140. The voltage of the first driving power (VDD) may be determined corresponding to the voltage code (Vcode).

The power generator 150 may provide a driving voltage suitable for driving to at least one of the scan driver 120, the data driver 130, the timing controller 140, and the current sensor 160. The power generator 150 may be implemented as a power management IC (PMIC).

The first driving power (VDD) may be supplied to the display 110 through the first power line (PL1). The second driving power (VSS) may be supplied to the display 110 through the second power line (PL2). The initialization power (VINT) may be supplied to the data driver 130 through the third power line (PL3). The first power line (PL1) and the second power line (PL2) may be commonly connected to the pixels (PX).

The sensing resistor (Rs) may be connected to the first power line (PL1) that is commonly connected to the pixels (PX). For example, the sensing resistor (Rs) may be connected between the first power line (PL1) and the display 110. In this case, the voltage (and current) of the first driving power (VDD) may be supplied to the display 110 via the sensing resistor (Rs).

The current sensor 160 may be electrically connected to both ends of the sensing resistor (Rs). The current sensor 160 may sense the current flowing through the sensing resistor (Rs) to generate a global current value (GC). The global current value (GC) generated (or detected) by the current sensor 160 may be provided to the timing controller 140.

The global current value (GC) may correspond to a current commonly supplied to the pixels (PX) through the first power line (PL1). However, embodiments of the present disclosure are not limited thereto, and for example, the sensing resistor (Rs) may be connected to the second power line (PL2) commonly connected to the pixels (PX) to sense the current flowing in the second power line (PL2). In this case, the current sensor 160 may generate the global current value (GC) from the sensing resistor (Rs) connected to the second power line (PL2).

The timing controller 140 may receive input data (Din) and a control signal (CS) from the outside (e.g., from a graphic processor, an application processor, etc.), and may generate the scan control signal (SCS) and the data control signal (DCS) based on the control signal (CS).

In one or more embodiments, the timing controller 140 may control the voltage of the first driving power (VDD) on a frame basis corresponding to the load and peak grayscale of the pixels (PX). For example, the timing controller 140 may generate the voltage code (Vcode) so that the first driving power (VDD) has a voltage (e.g., a predetermined voltage) value corresponding to the load and peak grayscale of the pixels (PX).

In one or more embodiments, the timing controller 140 may compare the voltage of the first driving power (VDD) of the current frame with the voltage of the first driving power (VDD) of the previous frame, and control the rising slope (or voltage rising time) of the first driving power (VDD) in response to the comparison result.

In one or more embodiments, the timing controller 140 may compare the global current value (GC) with the maximum current value that should actually flow corresponding to the load of the current frame, and may control the rising slope of the first driving power (VDD) in response to the comparison result. The global current value (GC) may correspond to a current value that actually flows to the pixels (PX).

In one or more embodiments, when the voltage of the first driving power (VDD) of the current frame and the voltage of the first driving power (VDD) of the previous frame have a voltage difference that is greater than or equal to a first threshold value, while at the same time the global current value (GC) and the maximum current value have a current difference that is greater than or equal to a second threshold value, the timing controller 140 may control the power generator 150 so that the first driving power (VDD) is risen in a step-wave form. For example, the timing controller 140 may generate the voltage code (Vcode) so that the first driving power (VDD) is risen in a step-wave form.

FIG. 2 is a diagram illustrating one or more embodiments of a pixel illustrated in FIG. 1. In FIG. 2, a pixel (PX) located at an i^{th} row and a j^{th} column is illustrated. The pixel (PX) illustrated in FIG. 2 is one or more embodiments, and the structure of the pixel (PX) of the present disclosure is not limited thereto. For example, in one or more embodiments of the present disclosure, the pixel (PX) may be selected from among various circuits known at present.

Referring to FIG. 2, the pixel (PX) may be connected to the first scan line (SLi), second scan line (SSLi), data line (DLj), and read-out line (RLj).

The pixel (PX) may include a light-emitting element (LD), a first transistor (T1) (or a driving transistor), a second transistor (T2), a third transistor (T3), and a storage capacitor (Cst). Each of the first transistor (T1), the second transistor (T2), and the third transistor (T3) may be a thin film transistor including an oxide semiconductor, but is not limited thereto, and for example, at least some of the first transistor (T1), the second transistor (T2), and the third transistor (T3) may include a polysilicon semiconductor or may be implemented as an N-type semiconductor or a P-type semiconductor.

A first electrode (or anode electrode) of the light-emitting element (LD) may be connected to the first power line (PL1) via a second node (N2) and the first transistor (T1), and a second electrode (or cathode electrode) may be connected to the second power line (PL2). The light-emitting element (LD) may emit light having a brightness corresponding to the driving current supplied from the first transistor (T1).

The light-emitting element (LD) may be selected as an organic light-emitting diode. In addition, the light-emitting element (LD) may be selected as an inorganic light-emitting diode, such as a micro light-emitting diode (LED) or a quantum dot light-emitting diode. In addition, the light-emitting element (LD) may be an element composed of a composite of an organic material and an inorganic material. In FIG. 2, the pixel (PX) is illustrated as including a single light-emitting element (LD), but in other embodiments, the pixel (PX) includes a plurality of light-emitting elements, and the plurality of light-emitting elements may be connected in series, in parallel, or in series-parallel.

A first electrode (e.g., a drain electrode) of the first transistor (T1) may be connected to the first power line (PL1) to which the first driving power (VDD) is applied, and a second electrode (e.g., a source electrode) may be connected to the second node (N2). A gate electrode of the first transistor (T1) may be connected to the first node (N1). The first transistor (T1) may control the amount of current flowing to the light-emitting element (LD) corresponding to a voltage of the first node (N1) (or a gate-source voltage applied between the gate electrode and the second electrode of the first transistor (T1)).

A first electrode of the second transistor (T2) may be connected to the data line (DLj), and a second electrode may be connected to the first node (N1). A gate electrode of the second transistor (T2) may be connected to the first scan line (SLi). When the first scan signal is supplied to the first scan line (SLi), the second transistor (T2) may be turned on to transfer a data signal (VDATA) from the data line (DLj) to the first node (N1).

The storage capacitor (Cst) may be formed, or may be connected, between the first node (N1) and the second node (N2). The storage capacitor (Cst) may store the voltage of the first node (N1).

The third transistor (T3) may be connected between the read-out line (RLj) and the second node (N2). A gate electrode of the third transistor (T3) may be connected to the second scan line (SSLi). When the second scan signal is supplied to the second scan line (SSLi), the third transistor (T3) may be turned on to transfer the voltage of the initialization power (VINT) from the read-out line (RLj) to the second node (N2).

When the second transistor (T2) and the third transistor (T3) are concurrently or substantially simultaneously turned on in response to the first scan signal and the second scan signal, a voltage difference between the data signal (VDATA) and the initialization power (VINT) is stored in the storage capacitor (Cst). The first transistor (T1) may control the amount of current flowing to the light-emitting element (LD) corresponding to the voltage difference stored in the storage capacitor (Cst).

In contrast, when the third transistor (T3) is turned on during the sensing period and the second node (N2) and the read-out line (RLj) are connected, the sensing signal may be provided from the pixel (PX) to the read-out line (RLj).

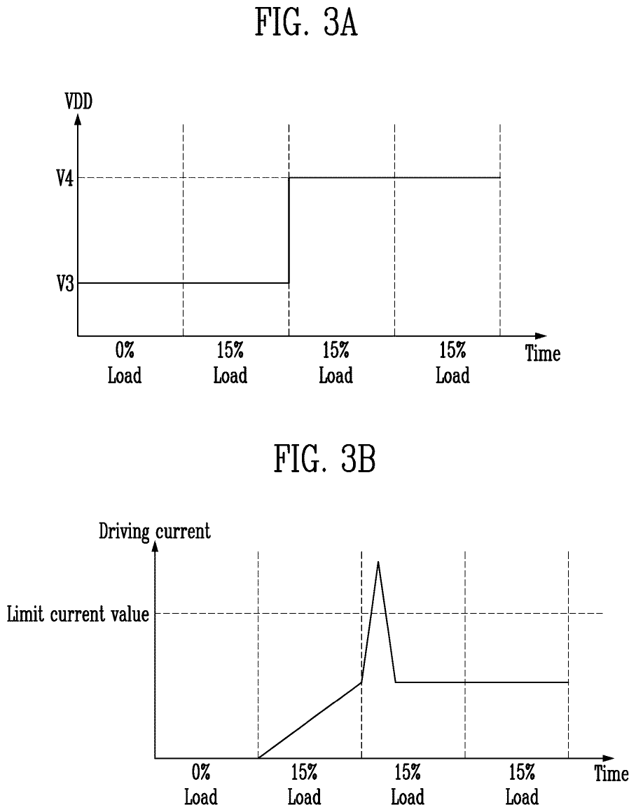

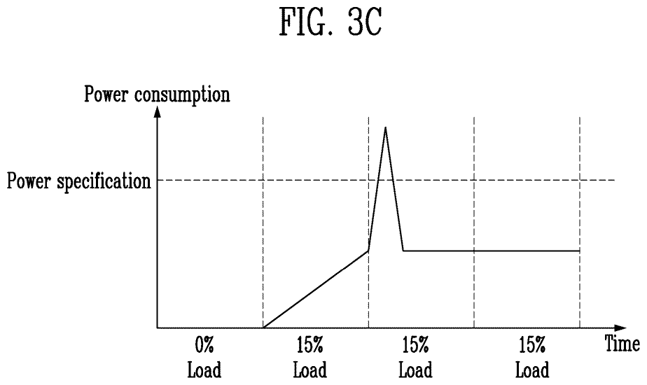

FIGS. 3A to 3C are diagrams illustrating driving current and power consumption when a voltage of a first driving power is reflected with a delay of one frame. In FIG. 3A, the Y-axis represents the voltage of the first driving power (VDD), and the X-axis represents the change in load over time. In FIG. 3B, the Y-axis represents the driving current supplied to the display 110, and the X-axis represents the change in load over time. In FIG. 3C, the Y-axis represents power consumption, and the X-axis represents the change in load over time.

Referring to FIG. 3A, when the load of the display 110 is 0%, the power generator 150 may supply the first driving power (VDD) of a third voltage (V3) to the pixels (PX) corresponding to the voltage code (Vcode) generated by the timing controller 140.

When the load of the display 110 changes from 0% to 15%, the voltage of the first driving power (VDD) may be suitably risen to a fourth voltage (V4). However, during a period (for example, one frame) in which the timing controller 140 analyzes the load and peak grayscale of the input data (Din), the voltage of the first driving power (VDD) is maintained at the third voltage (V3), and accordingly, the first driving power (VDD) may be delayed by one frame and changed to the fourth voltage (V4). In other words, in the first frame in which the load of the display 110 changes from 0% to 15%, the first driving power (VDD) maintains the third voltage (V3).

Referring to FIG. 3B, when the load changes from 0% to 15%, the data driver 130 may supply a data signal corresponding to the load of 15% to the display 110. Then, each of the pixels (PX) may supply a driving current corresponding to the data signal of the load of 15% to the light-emitting element (LD). In this case, the driving current of the display 110 increases, which may be sensed as the global current value (GC).

In the first frame in which the load of the display 110 changes from 0% to 15%, the first driving power (VDD) maintains the third voltage (V3), and accordingly, the driving transistors (e.g., the first transistor (T1)) included in each of the pixels (PX) may be driven in a linear region. When the driving transistors are driven in the linear region, the driving current may be gradually increased.

In the second frame, the voltage of the first driving power (VDD) may be risen to the fourth voltage (V4). When the voltage of the first driving power (VDD) is risen to the fourth voltage (V4), the driving transistors may be driven in a saturation region, and accordingly, the driving current may be rapidly increased. For example, the driving current of the display 110 in the second frame may exceed a limit current value (e.g., preset limit current value).

Referring to FIG. 3C, power consumption may be gradually increased in response to the increase in driving current in the first frame where the load of the display 110 changes from 0% to 15%. In addition, in response to the rapid increase in driving current in the second frame, power consumption may also be rapidly increased. For example, power consumption in the second frame may exceed a power specification (e.g., a preset power specification).

As described above, if the driving current supplied to the display 110 exceeds the limit current value, or if the power consumption exceeds the power specification, the display device 100 may malfunction. In addition, if the driving current supplied to the display 110 exceeds the limit current value, or if the power consumption exceeds the power specification, the display device 100 may be determined to be defective, and thus the manufacturing cost may be increased.

In one or more embodiments of the present disclosure, the timing controller 140 may determine in advance whether the driving current supplied to the display 110 exceeds the limit current value or the power consumption exceeds the power specification, and control the voltage of the first driving power (VDD) to be risen stepwise in response thereto.

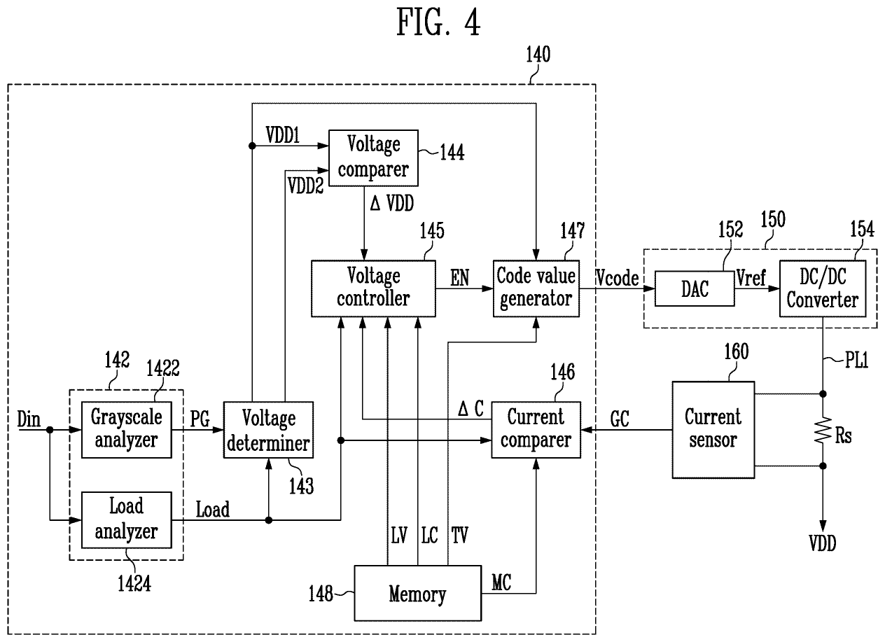

FIG. 4 is a diagram illustrating a timing controller and a power generator according to one or more embodiments of the present disclosure.

Referring to FIG. 4, the power generator 150 according to one or more embodiments of the present disclosure may include a digital-to-analog converter (DAC) 152 and a DC-DC converter 154.

The DAC 152 may generate a reference voltage (Vref) (or feedback voltage) corresponding to the voltage code (Vcode), and may supply the reference voltage (Vref) to the DC-DC converter 154. For example, the DAC 152 may supply the reference voltage (Vref) between about 0 V and about 3.3 V (or up to about 4.8 V) corresponding to the voltage code (Vcode) to the DC-DC converter 154.

The DC-DC converter 154 may generate the first driving power (VDD) of a voltage (e.g., a predetermined voltage) based on the reference voltage (Vref), and may supply the first driving power (VDD) to the first power line (PL1). The voltage of the first driving power (VDD) generated by the DC-DC converter 154 may be determined based on the voltage (e.g., voltage code (Vcode)) of the reference voltage (Vref).

The timing controller 140 according to one or more embodiments of the present disclosure may include an analyzer 142, a voltage determiner 143, a voltage comparer 144, a voltage controller 145, a current comparer 146, a code value generator 147, and a memory 148. The timing controller 140 may include various other components, but only the components suitable for explaining the present disclosure are illustrated in FIG. 4.

The analyzer 142 may calculate (or analyze) the load of the input data (Din), or may extract the peak grayscale (or maximum grayscale) (PG). To this end, the analyzer 142 may include a grayscale analyzer 1422 and a load analyzer 1424.

The grayscale analyzer 1422 may extract a peak grayscale (PG) from the input data (Din) of one frame. Here, the peak grayscale (PG) may mean the highest grayscale among the input data (Din) included in one frame.

The load analyzer 1424 may calculate the load of the input data (Din) corresponding to one frame. For example, the load analyzer 1424 may calculate the load by averaging the grayscales of the input data (Din) of one frame. Various methods known locally may be used as a method for calculating the load in the load analyzer 1424.

The voltage determiner 143 may determine the voltage of the first driving power (VDD) corresponding to the peak grayscale (PG) and the load. The voltage determiner 143 may supply the voltage (for example, the first voltage (VDD1)) of the first driving power (VDD) corresponding to the p frame (for example, the current frame), and may supply the voltage (for example, the second voltage (VDD2)) of the first driving power (VDD) corresponding to the p−1 frame (for example, the previous frame), to the voltage comparer 144.

The voltage comparer 144 may compare the first voltage (VDD1) and the second voltage (VDD2), and may supply the voltage difference value (ΔVDD) of the first voltage (VDD1) and the second voltage (VDD2) in response to the comparison result to the voltage controller 145. The voltage controller (145) may know the voltage difference of the first driving power (VDD) between the current frame and the previous frame by using the voltage difference value (ΔVDD).

The current comparer 146 may receive the global current value (GC) from the current sensor 160, and may receive the load from the analyzer 142. The current comparer 146 that received the load may receive (or extract) a maximum current value (MC) that may flow in the display 110 corresponding to the load from the memory 148. The current comparer 146 may compare the maximum current value (MC) with the global current value (GC) and, in response to the comparison result, may supply the differential current value (ΔC) between the maximum current value (MC) and the global current value (GC) to the voltage controller 145.

The memory 148 may be provided with a plurality of lookup tables. The memory 148 may provide a threshold voltage value (LV) corresponding to the load, along with a threshold current value (LC) corresponding to the load, to the voltage controller 145. The memory 148 may provide the maximum current value (MC) corresponding to the load to the current comparer 146. The memory 148 may provide time/voltage information (TV) to the code value generator 147.

The voltage controller 145 may receive the load from the analyzer 142. The voltage controller 145 may receive the differential voltage value (ΔVDD) from the voltage comparer 144, and may receive the differential current value (ΔC) from the current comparer 146. The voltage controller 145 may receive the threshold voltage value (LV) and the threshold current value (LC) from the memory 148.

The voltage controller 145 compares the differential voltage value (ΔVDD) with the threshold voltage value (LV) corresponding to the load, and compares the differential current value (ΔC) with the threshold current value (LC) corresponding to the load. In addition, the voltage controller 145 may supply an enable signal (EN) to the code value generator 147 when the differential voltage value (ΔVDD) is greater than the threshold voltage value (LV), and when the differential current value (ΔC) is greater than the threshold current value (LC). The enable signal (EN) may be a high voltage (or low voltage), and may remain at a low voltage (or high voltage) when the enable signal (EN) is not supplied.

The code value generator 147 may receive the voltage of the first driving power (VDD) corresponding to the current frame (e.g., the first voltage (VDD1)) from the voltage determiner 143, and may receive time/voltage information (TV) from the memory 148. When the enable signal (EN) is not supplied from the voltage controller 145, the code value generator 147 may generate a voltage code (Vcode) corresponding to the first voltage (VDD1), and may supply it to the power generator 150. In this case, the power generator 150 may generate the first driving power (VDD) of the first voltage (VDD1) corresponding to the voltage code (Vcode), and may supply it to the display 110. In other words, when the enable signal (EN) is not supplied from the voltage controller 145, the first driving power (VDD) may be relatively quickly risen to the first voltage (VDD1).

When the enable signal (EN) is supplied from the voltage controller 145, the code value generator 147 may generate the voltage code (Vcode) using the time/voltage information (TV) so that the voltage of the first driving power (VDD) is gradually risen to the first voltage (VDD1). The time/voltage information (TV) includes time information and voltage information, and the code value generator 147 may generate the voltage code (Vcode) so that the voltage of the first driving power (VDD) is risen stepwise by the voltage included in the voltage information for each time period included in the time information. In this case, the voltage of the first driving power (VDD) may be gradually risen to the first voltage (VDD1) in a step-wave form.

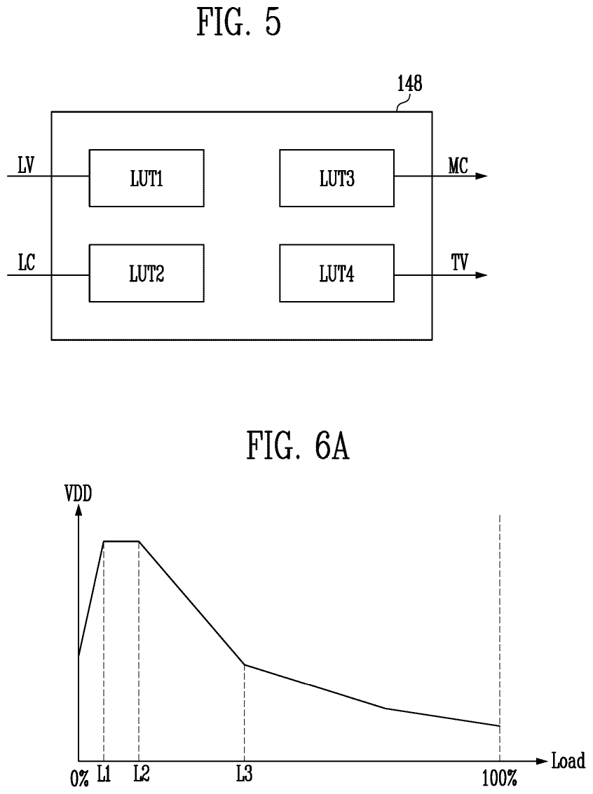

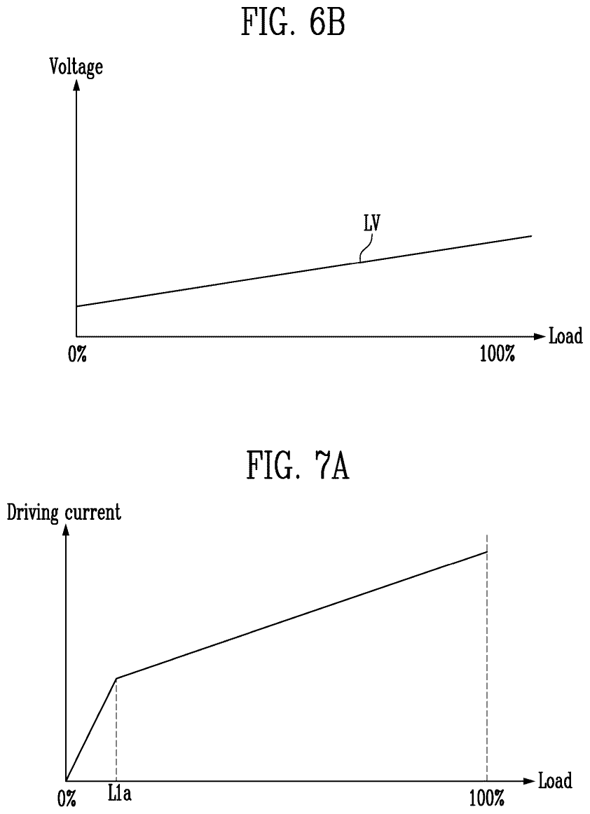

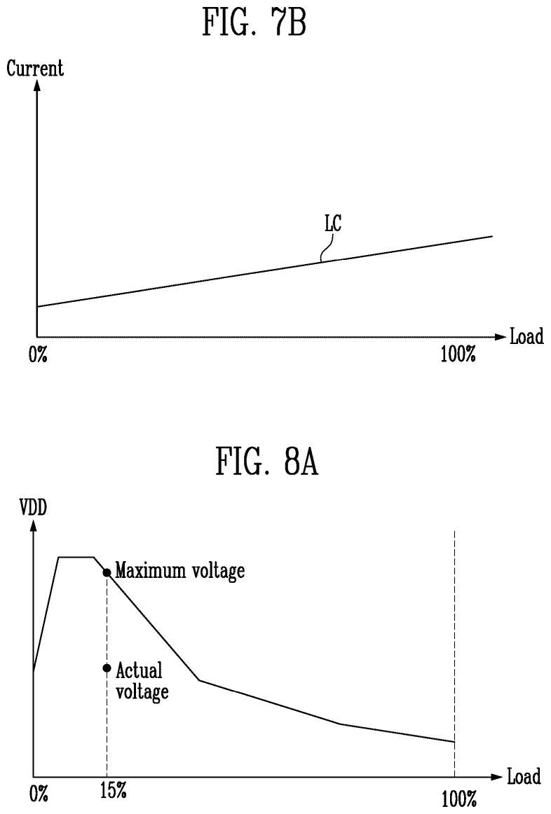

FIG. 5 is a diagram illustrating one or more embodiments of a memory illustrated in FIG. 4. FIGS. 6A and 6B are diagrams for explaining a threshold voltage value. FIGS. 7A and 7B are diagrams for explaining a threshold current value.

Referring to FIG. 5, a memory 148 according to one or more embodiments of the present disclosure may be provided with a first lookup table (LUT1), a second lookup table (LUT2), a third lookup table (LUT3), and a fourth lookup table (LUT4).

Referring to FIG. 6A, the voltage of the first driving power (VDD) may be set differently corresponding to the load.

In one or more embodiments, the voltage of the first driving power (VDD) may be rapidly risen, or increased, to a first load (L1), and may maintain a constant voltage from the first load (L1) to a second load (L2). In addition, the voltage of the first driving power (VDD) may be dropped, or decreased, from a second load (L2) to a third load (L3) at a first slope, and may be dropped at a second slope (e.g., one or more second slopes) that is less than the first slope from the third load (L3). Here, the first slope and the second slope are for describing the dropping time of the first driving power (VDD), and in reality, the voltage of the first driving power (VDD) may be dropped with various slopes other than the first slope and the second slope.

The first driving power (VDD) may be dropped by a relatively low voltage between the third load (L3) and the 100% load. In other words, the voltage of the first driving power (VDD) at the third load (L3) and the voltage of the first driving power (VDD) at the 100% load may have a relatively low voltage difference. For example, the first driving power (VDD) may be set to relatively a low voltage at a high load so that the power consumption may be maintained at an approximately constant value.

As described above, the voltage of the first driving power (VDD) may be set to have a large voltage fluctuation range when the load is lower than the third load (L3), and may be set to have a small voltage fluctuation range when the load is higher than the third load (L3). In other words, when the load of the display 110 is high, the probability that the power consumption will exceed the power specification due to a sudden increase in voltage may be reduced.

The threshold voltage value (LV) corresponding to the load may be stored in the first lookup table (LUT1), as shown in FIG. 6B. Here, the threshold voltage value (LV) may increase in proportion to the load. In other words, the threshold voltage value (LV) may be set to relatively a high voltage value when the load is large, and may be set to a relatively low voltage value when the load is small.

For example, when the load of the display 110 is high, the probability that the power consumption of the display device 100 will exceed the power specification is low, so the threshold voltage value (LV) may be set to relatively a high value. When the load is low, the probability that the power consumption of the display device 100 will exceed the power specification is high, so the threshold voltage value (LV) may be set to a relatively low value.

Referring to FIG. 7A, the driving current of the display 110 may be increased corresponding to the load.

In one or more embodiments, the driving current of the display 110 may be risen (e.g., may increase) at a third slope up to the first load (L1a), and may be risen at a fourth slope that is less than the third slope when it exceeds the first load (L1a). Here, the third slope and the fourth slope are for explaining the rising time of the driving current, and in reality, the driving current may be risen with various slopes other than the third slope and the fourth slope.

The driving current of the display 100 has a smaller current increase amount when the load is high. In other words, when the load of the display 110 is high, the probability of exceeding the limit current value due to a sudden current increase may be lowered.

In the second lookup table (LUT2), the threshold current value (LC) corresponding to the load may be stored, as shown in FIG. 7B. Here, the threshold current value (LC) may be increased in proportion to the load. In other words, the threshold current value (LC) may be set to a relatively high current value when the load is large, and may be set to a relatively low current value when the load is small.

For example, when the load of the display 110 is high, the probability that the driving current of the display device 100 will exceed the limit current value is relatively low, so the threshold current value (LC) may be set large, and when the load is low, the probability that the driving current of the display device 100 will exceed the limit current value is relatively high, so the threshold current value (LC) may be set low.

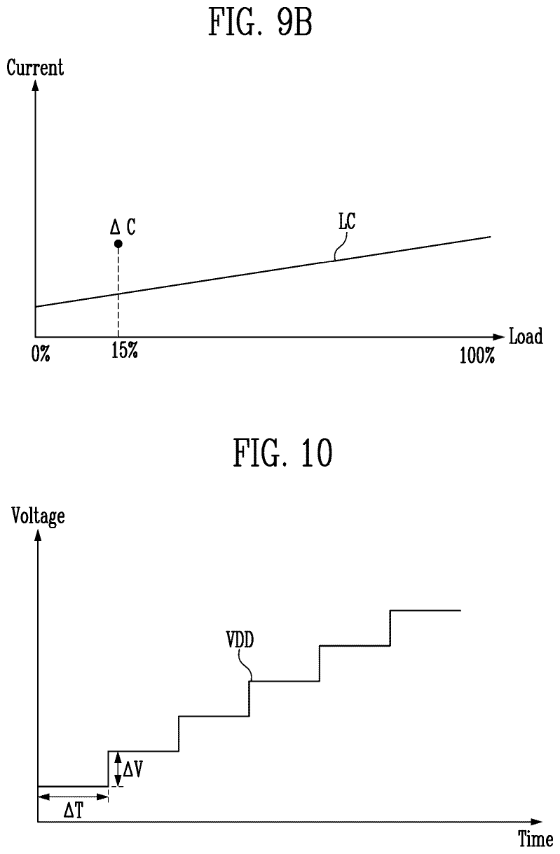

In the third lookup table (LUT3), the maximum current value (MC) that may flow to the display 110 corresponding to the load may be stored. Here, the maximum current value (MC) may correspond to an actual driving current value that should flow to the display 110 corresponding to the load. For example, the maximum current value (MC) may correspond to the maximum current corresponding to the load illustrated in FIG. 9A, and may be increased in proportion to the load.

In the fourth lookup table (LUT4), time/voltage information (TV) may be stored. The time/voltage information (TV) may include time information and voltage information so that the first driving power (VDD) may be risen in a step-wave form. Here, the time information may refer to a time for which the first driving power (VDD) maintains a constant voltage, and the voltage information may refer to a voltage to which the first driving power (VDD) may be risen. For example, by the control of the code value generator 147, the first driving power (VDD) may be risen by a voltage included in the voltage information for each time period included in the time information.

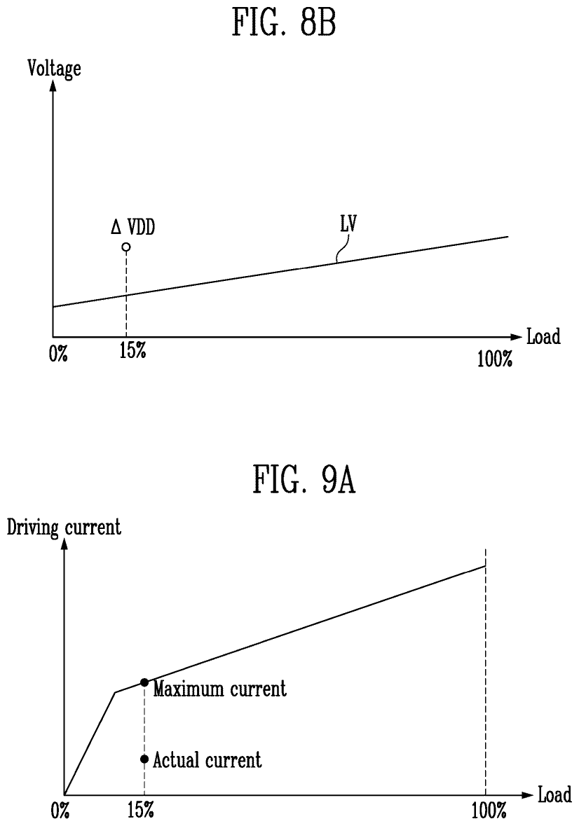

FIGS. 8A to 9B are diagrams illustrating an operation process of a voltage controller. FIG. 10 is a diagram illustrating an operation process of a code value generator. In FIG. 8A, the Y-axis represents the first driving power (VDD) and the X-axis represents the load. In FIG. 8B, the Y-axis represents voltage and the X-axis represents the load. In FIG. 9A, the Y-axis represents driving current and the X-axis represents the load. In FIG. 9B, the Y-axis represents current and the X-axis represents the load. In FIG. 10, the Y-axis represents voltage and the X-axis represents time.

Referring to FIGS. 3A, 4, 8A, and 8B, in the first frame where the load of the display device 100 is changed from 0% to 15%, the ideal (e.g., near ideal) voltage of the first driving power (VDD) may be the fourth voltage (V4) (the maximum voltage in FIG. 8A), and the actual voltage of the first driving power (VDD) may be set to the third voltage (V3).

The voltage comparer 144 may receive the first voltage (VDD1) of the first driving power (VDD) corresponding to the current frame, along with the second voltage (VDD2) of the first driving power (VDD) corresponding to the previous frame, from the voltage determiner 143. Here, the first voltage (VDD1) may correspond to a 15% load, and the second voltage (VDD2) may correspond to a 0% load. The voltage comparer 144 may supply the differential voltage value (ΔVDD) of the first voltage (VDD1) and the second voltage (VDD2) to the voltage controller 145.

The voltage controller 145 may compare the differential voltage value (ΔVDD) with the threshold voltage value (LV) corresponding to the load (for example, a 15% load). Here, the differential voltage value (ΔVDD) may be set to be greater than the threshold voltage value (LV). When the differential voltage value (ΔVDD) is set to be greater than the threshold voltage value (LV), the first condition for generating the enable signal (EN) may be satisfied.

Referring to FIGS. 9A and 9B, in the first frame where the load of the display device 100 is changed from 0% to 15%, the actual current of the display 110 may be set lower by comparing the driving current that should flow to the display 110 in response to the load with the maximum current.

Here, the maximum current is provided to the current comparer 146 as the maximum current value (MC) corresponding to the load, and the actual current may be provided to the current comparer 146 as the global current value (GC). The current comparer 146 may supply the differential current value (ΔC) of the maximum current value (MC) and the global current value (GC) to the voltage controller 145.

The voltage controller 145 may compare the differential current value (ΔC) with the threshold current value (LC) corresponding to the load (for example, a load of 15%). Here, the differential current value (ΔC) may be set to be greater than the threshold current value (LV). When the differential current value (ΔC) is set to be greater than the threshold current value (LC), the second condition for generating the enable signal (EN) may be satisfied.

When the first condition and the second condition are satisfied, the voltage controller 145 may supply the enable signal (EN) to the code value generator 147. When the enable signal (EN) is input, the code value generator 147 may generate the voltage code (Vcode) using the time/voltage information (TV) so that the voltage of the first driving power (VDD) is risen stepwise.

For example, the code value generator 147 may generate the voltage code (Vcode) so that the first driving power (VDD) is generated by a voltage (e.g., a predetermined voltage) (ΔV) at a time (ΔT) period, as illustrated in FIG. 10. In this case, the power generator 150 may supply the first driving power (VDD), whose voltage is risen in a step-wave form to the display 110.

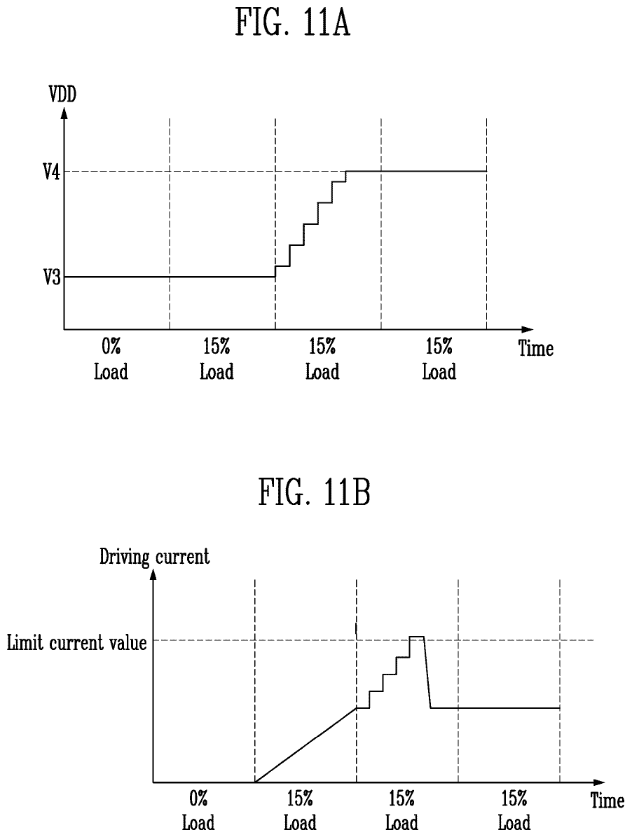

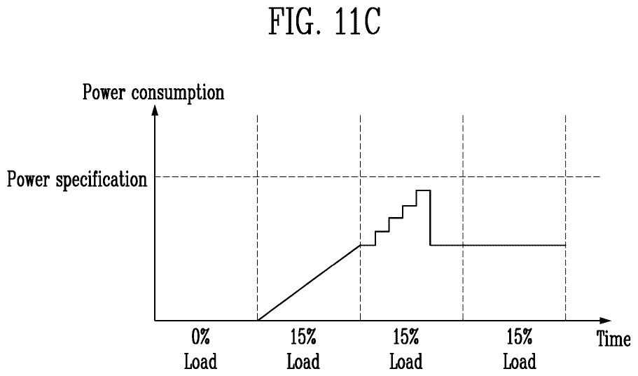

FIGS. 11A to 11C are diagrams illustrating driving current and power consumption when a voltage of a first driving power is reflected with a delay of one frame according to one or more embodiments of the present disclosure. In FIG. 11A, the Y-axis represents the voltage of the first driving power (VDD), and the X-axis represents the change in the load over time. In FIG. 11B, the Y-axis represents the driving current flowing in the display, and the X-axis represents the change in the load over time. In FIG. 11C, the Y-axis represents power consumption, and the X-axis represents the change in the load over time.

Referring to FIG. 11A, when the load of the display 110 is 0%, the power generator 150 may supply the first driving power (VDD) of the third voltage (V3) to the pixels (PX) corresponding to the voltage code (Vcode) generated by the timing controller 140.

When the load of the display 110 is changed from 0% to 15% (e.g., in the first frame after the load of the display 110 is changed from 0% to 15%), the first driving power (VDD) maintains the third voltage (V3) in the first frame. In addition, after the load of the display 110 is changed from 0% to 15%, the first driving power (VDD) may be gradually risen in a step-wave form in the second frame.

Referring to FIG. 11B, when the load of the display 110 is changed from 0% to 15%, the data signal corresponding to the load of 15% may be supplied to the display 110. In this case, the driving current of the display 110 may be increased, and accordingly, the global current value (GC) may be increased. However, in the first frame in which the load of the display 110 is changed from 0% to 15% (e.g., in the first frame after the load of the display 110 is changed from 0% to 15%), the first driving power (VDD) maintains the third voltage (V3), and accordingly, the driving transistors included in each of the pixels (PX) may be driven in a linear region. When the driving transistors are driven in the linear region, the driving current (or, the global current value (GC)) may be gradually increased.

In the second frame, the voltage of the first driving power (VDD) may be gradually increased in a step-wave form, and accordingly, the driving current of the display 110 may also be gradually increased in a step-wave form. In this case, the driving current of the display 110 may not exceed the limit current value. In addition, when the driving current of the display 110 exceeds the limit current value, the time for which it exceeds may be set short and the current value for which it exceeds may be set low.

Referring to FIG. 11C, in the first frame where the load of the display 110 is changed from 0% to 15%, the power consumption may be gradually increased in response to the increase in the driving current of the display 110. In addition, because the driving current of the display 110 is gradually increased in the second frame, the power consumption may also be gradually increased. In this case, the power consumption of the display device 100 may not exceed the power specification, and thus the stability of driving may be secured.

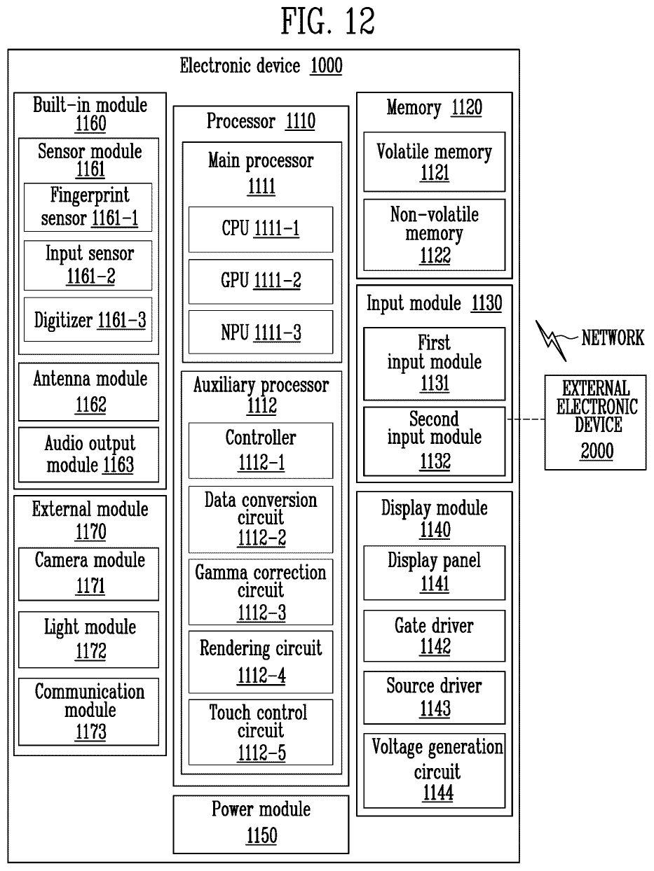

FIG. 12 is a diagram illustrating an electronic device according to one or more embodiments of the present disclosure.

Referring to FIG. 12, an electronic device 1000 according to one or more embodiments of the present disclosure outputs various information through a display module 1140. When the processor 1110 executes an application stored in a memory 1120, the display module 1140 provides application information to the user through a display panel 1141.

The processor 1110 acquires external input through an input module 1130 or a sensor module 1161, and executes an application corresponding to the external input. For example, when a user selects a camera icon (or a camera application icon) displayed on the display panel 1141, the processor 1110 acquires user input through an input sensor 1161-2 and activates a camera module 1171. The processor 1110 transfers image data corresponding to a captured image acquired through the camera module 1171 to the display module 1140. The display module 1140 may display an image corresponding to the captured image through the display panel 1141.

As another example, when personal information authentication is executed in the display module 1140, a fingerprint sensor 1161-1 acquires input fingerprint information as input data. The processor 1110 compares the input data acquired through the fingerprint sensor 1161-1 with the authentication data stored in the memory 1120, and executes an application according to the comparison result. The display module 1140 may display information executed according to the logic of the application through the display panel 1141. The fingerprint sensor 1161-1 may be arranged so as to acquire fingerprint information in the entire area of the display module 1140 (or the display panel 1141).

As another example, when a music streaming icon displayed on the display module 1140 is selected, the processor 1110 acquires user input through the input sensor 1161-2, and activates a music streaming application stored in the memory 1120. When a music execution command is input in the music streaming application, the processor 1110 activates an audio output module 1163 to provide the user with audio information corresponding to the music execution command.

In the above, the operation of the electronic device 1000 has been briefly described. Hereinafter, the configuration of the electronic device 1000 will be described in detail. Some of the configurations of the electronic device 1000 described below may be integrated and provided as one configuration, and one configuration may be provided by being separated into two or more configurations.

The electronic device 1000 may communicate with an external electronic device 2000 via a network (e.g., a short-range wireless communication network or a long-range wireless communication network). According to one or more embodiments, the electronic device 1000 may include the processor 1110, the memory 1120, the input module 1130, the display module 1140, a power module 1150, a built-in module 1160, and an external module 1170. According to one or more embodiments, the electronic device 1000 may omit at least one of the above-described components, or may have one or more other components added. According to one or more embodiments, some of the above-described components (e.g., the sensor module 1161, an antenna module 1162, or an audio output module 1163) may be integrated into another component (e.g., the display module 1140).

The processor 1110 may execute software to control at least one other component (e.g., a hardware or software component) of the electronic device 1000 connected to the processor 1110, and may perform various data processing or calculations. According to one or more embodiments, as at least part of data processing or calculation, the processor 1110 may store commands or data received from another component (e.g., the input module 1130, the sensor module 1161, or a communication module 1173) in a volatile memory 1121, may process the commands or data stored in the volatile memory 1121, and may store resulting data in a nonvolatile memory 1122.

The processor 1110 may include a main processor 1111 and an auxiliary processor 1112. The main processor 1111 may include a central processing unit (CPU) 1111-1. The main processor 1111 may further include any one or more of a graphic processing unit (GPU) 1111-2, a communication processor (CP), and an image signal processor (ISP). The main processor 1111 may further include a neural processing unit (NPU) 1111-3. The NPU 1111-3 is a processor specialized in processing an artificial intelligence model, and the artificial intelligence model may be generated through machine learning. The artificial intelligence model may include a plurality of artificial neural network layers. The artificial neural network may be deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-networks, or a combination of two or more of the above, but is not limited to the examples described above. In addition to the hardware structure, the artificial intelligence model may additionally or alternatively include a software structure. At least two of the processing units and processors described above may be implemented as a single integrated configuration (e.g., a single chip), or each may be implemented as an independent configuration (e.g., a plurality of chips).

The auxiliary processor 1112 may include a controller 1112-1. The controller 1112-1 may include an interface conversion circuit and a timing control circuit. For example, the controller 1112-1 may include the timing controller 140 illustrated in FIG. 1. The controller 1112-1 receives an image signal from the main processor 1111, converts the data format of the image signal to match the interface specifications with the display module 1140, and outputs the image data. The controller 1112-1 may output various control signals suitable for driving the display module 1140.

The controller 1112-1 may generate the voltage code (Vcode) so that the rising time of the first driving power (VDD) is changed by using the differential voltage value (ΔVDD) of the first driving power (VDD) between the previous frame and the current frame, the maximum current value (MC) that should actually flow to the display panel 1141 corresponding to the load, and the differential current value (ΔC) of the global current value (GC) sensed from the display panel 1141. To this end, the controller 1112-1 may include the analyzer 142, the voltage determiner 143, the voltage comparer 144, the voltage controller 145, the current comparer 146, the code value generator 147, and the memory 148 as shown in FIG. 4.

The auxiliary processor 1112 may further include a data conversion circuit 1112-2, a gamma correction circuit 1112-3, a rendering circuit 1112-4, a touch control circuit 1112-5, etc. The data conversion circuit 1112-2 may receive image data from the controller 1112-1, and may compensate for the image data so that the image is displayed at a desired brightness according to the characteristics of the electronic device 1000 or the user's settings, or convert the image data to reduce power consumption or compensate for afterimages or the like.

The gamma correction circuit 1112-3 may convert the image data or the gamma reference voltage, etc., so that the image displayed on the electronic device 1000 has a desired gamma characteristic. The rendering circuit 1112-4 may receive image data from the controller 1112-1, and may render the image data in consideration of the pixel layout of the display panel 1141 applied to the electronic device 1000.

The touch control circuit 1112-5 may supply a touch signal to the input sensor 1161-2, and may receive a sensing signal from the input sensor 1161-2 in response to the touch signal.

At least one of the data conversion circuit 1112-2, the gamma correction circuit 1112-3, the rendering circuit 1112-4, and the touch control circuit 1112-5 may be integrated into another component (e.g., the main processor 1111 or the controller 1112-1). At least one of the data conversion circuit 1112-2, the gamma correction circuit 1112-3, and the rendering circuit 1112-4 may also be integrated into the source driver 1143 described below.

The memory 1120 may store various data used by at least one component of the electronic device 1000 (e.g., the processor 1110 or the sensor module 1161), and input data or output data for commands related thereto. In addition, various setting data corresponding to the user's settings may be stored in the memory 1120. The memory 1120 may include at least one of the volatile memory 1121 and the nonvolatile memory 1122.

The input module 1130 may receive commands or data to be used in components of the electronic device 1000 (e.g., the processor 1110, the sensor module 1161, or the audio output module 1163) from an external source of the electronic device 1000 (e.g., the user or the external electronic device 2000).

The input module 1130 may include a first input module 1131 into which a command or data is input from the user, and a second input module 1132 into which a command or data is input from the external electronic device 2000. The first input module 1131 may include a microphone, a mouse, a keyboard, keys (e.g., buttons), or a pen (e.g., a passive pen or an active pen). The second input module 1132 may support a designated protocol that may be connected to the external electronic device 2000 via wired or wireless means. According to one or more embodiments, the second input module 1132 may include a high definition multimedia interface (HDMI), a universal serial bus (USB) interface, an SD card interface, or an audio interface. The second input module 1132 may include a connector that may be physically connected to the external electronic device 2000, for example, an HDMI connector, a USB connector, an SD card connector, or an audio connector (e.g., a headphone connector).

The display module 1140 provides information visually to the user. The display module 1140 may include the display panel 1141, a gate driver 1142, a source driver 1143, and a voltage generation circuit 1144. The display module 1140 may further include a window, a chassis, and a bracket for protecting the display panel 1141. Such a display module 1140 may include at least a part of the configuration of the display device 100 illustrated in FIG. 1.

The display panel 1141 (or display) may include a liquid crystal display panel, an organic light-emitting display panel, or an inorganic light-emitting display panel, and the type of the display panel 1141 is not particularly limited. The display panel 1141 may be a rigid type or a flexible type that is rollable or foldable. The display module 1140 may further include a supporter, a bracket, a heat dissipation member, etc., that supports the display panel 1141. The display panel 1141 may include the display 110 illustrated in FIG. 1.

The gate driver 1142 may be mounted on the display panel 1141 as a driving chip. In addition, the gate driver 1142 may be integrated into the display panel 1141. For example, the gate driver 1142 may include an amorphous silicon TFT gate driver circuit (ASG), a low temperature polycrystalline silicon TFT gate driver circuit (LTPS), or an oxide semiconductor TFT gate driver circuit (OSG) embedded in the display panel 1141. The gate driver 1142 receives a control signal from the controller 1112-1 and outputs scan signals to the display panel 1141 in response to the control signal. The gate driver 1142 may include the scan driver 120 illustrated in FIG. 1.

The display module 1140 may further include a light-emitting driver. The light-emitting driver outputs a light-emitting control signal to the display panel 1141 in response to a control signal received from the controller 1112-1. The light-emitting driver may be formed separately from the gate driver 1142 or may be integrated into the gate driver 1142.

The source driver 1143 receives a control signal from the controller 1112-1, converts image data into an analog voltage (e.g., a data signal) in response to the control signal, and then outputs the data signals to the display panel 1141. The source driver 1143 may include the data driver 130 illustrated in FIG. 1.

The source driver 1143 may be integrated into another component (e.g., the controller 1112-1). The functions of the interface conversion circuit and the timing control circuit of the controller 1112-1 described above may also be integrated into the source driver 1143. Additionally, the display module 1140 may further include the current sensor 160 illustrated in FIG. 1.

The voltage generation circuit 1144 may output various voltages suitable for driving the display panel 1141. For example, the voltage generation circuit 1144 may include the power generator 150 illustrated in FIG. 1. The voltage generation circuit 1144 may include the DAC 152 and the DC-DC converter 154 illustrated in FIG. 5. In one or more embodiments, the display panel 1141 may include pixels (PX) illustrated in FIG. 1.

In one or more embodiments, the source driver 1143 may convert data corresponding to red (R), green (G), and blue (B) included in image data received from the processor 1110 into a red data signal (or data voltage), a green data signal, and a blue data signal, and may provide to a plurality of pixel columns included in the display panel 1141 during one horizontal period.

The power module 1150 supplies power to components of the electronic device 1000. The power module 1150 may include a battery that charges a power voltage. The battery may include a non-rechargeable primary battery, a rechargeable secondary battery, or a fuel cell. The power module 1150 may include a power management integrated circuit (PMIC). The PMIC supplies power optimized for each of the modules described above and the modules described below. The power module 1150 may include a wireless power transmission/reception member electrically connected to the battery. The wireless power transmission/reception member may include a plurality of coil-shaped antenna radiators. In one or more embodiments, at least some of the configurations of the power module 1150 and the voltage generation circuit 1144 may be provided as one integrated unit. For example, the voltage generation circuit 1144 may be included in the power module 1150.

The electronic device 1000 may further include the built-in module 1160 and the external module 1170. The built-in module 1160 may include the sensor module 1161, the antenna module 1162, and the audio output module 1163. The external module 1170 may include the camera module 1171, a light module 1172, and the communication module 1173.

The sensor module 1161 may detect an input by a user's body or an input by a pen among the first input modules 1131, and may generate an electric signal or data value corresponding to the input. The sensor module 1161 may include at least one or more of the fingerprint sensor 1161-1, the input sensor 1161-2, and a digitizer 1161-3.

The fingerprint sensor 1161-1 may generate a data value corresponding to the user's fingerprint.

The input sensor 1161-2 may generate a data value corresponding to coordinate information of an input by the user's body or an input by the pen. The input sensor 1161-2 generates a change in electrostatic capacity due to the input as a data value. The input sensor 1161-2 may detect input by the passive pen or transmit and receive data with the active pen. The input sensor 1161-2 may also measure biosignals, such as blood pressure, moisture, or body fat. For example, when a user touches a part of his or her body to the sensor layer or the sensing panel and does not move for a certain period of time, the input sensor 1161-2 may detect a biosignal based on a change in an electric field caused by the part of his or her body and output information desired by the user to the display module 1140.

The digitizer 1161-3 may generate a data value corresponding to coordinate information of an input by the pen. The digitizer 1161-3 generates an electromagnetic change amount caused by the input as a data value. The digitizer 1161-3 may detect an input by the passive pen or transmit and receive data with the active pen.

At least one of the fingerprint sensor 1161-1, the input sensor 1161-2, and the digitizer 1161-3 may be implemented as a sensor layer formed on the display panel 1141 through a continuous process. At least one of the fingerprint sensor 1161-1, the input sensor 1161-2, and the digitizer 1161-3 may be located on an upper side of the display panel 1141, and one of the fingerprint sensor 1161-1, the input sensor 1161-2, and the digitizer 1161-3, for example, the digitizer 1161-3, may be located on a lower side of the display panel 1141.

At least two or more of the fingerprint sensor 1161-1, the input sensor 1161-2, and the digitizer 1161-3 may be formed to be integrated into one sensing panel through the same process. When integrated into one sensing panel, the sensing panel may be located between the display panel 1141 and the window located on the upper side of the display panel 1141. According to one or more embodiments, the sensing panel may be located on the window, and the position of the sensing panel is not particularly limited.

At least one of the fingerprint sensor 1161-1, the input sensor 1161-2, and the digitizer 1161-3 may be built into the display panel 1141. In other words, at least one of the fingerprint sensor 1161-1, the input sensor 1161-2, and the digitizer 1161-3 may be formed concurrently or substantially simultaneously through a process of forming elements (e.g., light-emitting elements, transistors, etc.) included in the display panel 1141.

In addition, the sensor module 1161 may generate an electric signal or data value corresponding to an internal state or an external state of the electronic device 1000. The sensor module 1161 may further include, for example, a gesture sensor, a gyro sensor, a pressure sensor, a magnetic sensor, an acceleration sensor, a grip sensor, a proximity sensor, a color sensor, an infrared (IR) sensor, a biometric sensor, a temperature sensor, a humidity sensor, or a light sensor.

The antenna module 1162 may include one or more antennas for transmitting or receiving a signal or power to or from the outside. According to one or more embodiments, the communication module 1173 may transmit or receive a signal to or from the external electronic device through an antenna suitable for a communication method. The antenna pattern of the antenna module 1162 may be integrated into one component of the display module 1140 (for example, the display panel 1141) or the input sensor 1161-2.

The audio output module 1163 is a device for outputting an audio signal to the outside of the electronic device 1000, and may include, for example, a speaker used for general purposes, such as multimedia playback or recording playback, and a receiver used exclusively for phone reception. According to one or more embodiments, the receiver may be formed integrally with or separately from the speaker. The audio output pattern of the audio output module 1163 may be integrated with the display module 1140.

The camera module 1171 may capture still images and moving images. According to one or more embodiments, the camera module 1171 may include one or more lenses, image sensors, or image signal processors. The camera module 1171 may further include an infrared camera capable of measuring the presence or absence of a user, the user's location, the user's line of sight, etc.

The light module 1172 may provide light. The light module 1172 may include a light-emitting diode or a xenon lamp. The light module 1172 may operate in conjunction with the camera module 1171 or may operate independently.

The communication module 1173 may support the establishment of a wired or wireless communication channel between the electronic device 1000 and the external electronic device 2000, and the performance of communication through the established communication channel. The communication module 1173 may include any one or all of a wireless communication module, such as a cellular communication module, a short-range wireless communication module, or a global navigation satellite system (GNSS) communication module, and a wired communication module, such as a local area network (LAN) communication module or a power line communication module. The communication module 1173 may communicate with the external electronic device 2000 via a short-range communication network, such as Wi-Fi® direct, Bluetooth® (Wi-Fi® being a registered trademark of the non-profit Wi-Fi Alliance, and Bluetooth® being a registered trademark of Bluetooth Sig, Inc., Kirkland, WA), or infrared data association (IrDA), or a long-range communication network, such as a cellular network, the Internet, or a computer network (e.g., a LAN or WAN). The various types of communication modules 1173 described above may be implemented as one chip or each may be implemented as a separate chip.

The input module 1130, the sensor module 1161, the camera module 1171, etc., may be utilized to control the operation of the display module 1140 in conjunction with the processor 1110.

The processor 1110 outputs a command or data to the display module 1140, the audio output module 1163, the camera module 1171, or the light module 1172 based on input data received from the input module 1130. For example, the processor 1110 may generate image data corresponding to input data applied through the mouse or active pen, etc., and output to the display module 1140, or may generate command data corresponding to the input data and output to the camera module 1171 or the light module 1172. When input data is not received from the input module 1130, the processor 1110 may reduce power consumption of the electronic device 1000 by switching the operation mode of the electronic device 1000 to a low power mode or a sleep mode.

The processor 1110 outputs a command or data to the display module 1140, the audio output module 1163, the camera module 1171, or the light module 1172 based on the sensing data received from the sensor module 1161. For example, the processor 1110 may compare authentication data authorized by the fingerprint sensor 1161-1 with authentication data stored in the memory 1120, and then may execute an application based on the comparison result. The processor 1110 may execute a command or output corresponding image data to the display module 1140 based on sensing data detected by the input sensor 1161-2 or the digitizer 1161-3. If the sensor module 1161 includes a temperature sensor, the processor 1110 may receive temperature data on the temperature measured from the sensor module 1161, and may further perform brightness correction and the like on the image data based on the temperature data.

The processor 1110 may receive measurement data on the presence or absence of a user, the position of the user, the line of sight of the user, etc., from the camera module 1171. The processor 1110 may further perform brightness correction and the like on the image data based on the measurement data. For example, the processor 1110 that determined the presence or absence of a user through input from the camera module 1171 may output image data whose brightness is corrected through the data conversion circuit 1112-2 or the gamma correction circuit 1112-3 to the display module 1140.

Some of the above components may be connected to each other through a communication method between peripheral devices, for example, a bus, a general purpose input/output (GPIO), a serial peripheral interface (SPI), a mobile industry processor interface (MIPI), or an ultra path interconnect (UPI) link, and may exchange signals (e.g., commands or data) with each other. The processor 1110 may communicate with the display module 1140 through a mutually agreed upon interface, and may use, for example, any one of the above-described communication methods, and is not limited to the above-described communication methods.

The electronic device 1000 may correspond to portable electronic devices, such as mobile phones, smartphones, tablet personal computers (PCs), mobile communication terminals, electronic notebooks, electronic books, portable multimedia players (PMPs), navigations, and ultra-mobile PCs (UMPCs). For example, the display device 100 of FIG. 1 may be applied to a display unit of a television, a laptop computer, a monitor, a billboard, or the Internet of Things (IoT). Alternatively, in one or more embodiments, the display device 100 may be applied to a smartwatch, a watch phone, and/or a head-mounted display device (HMD) for implementing virtual reality and/or augmented reality.

Although the present disclosure has been described above with reference to embodiments thereof, it will be understood by those skilled in the art that various modifications and changes may be made to the present disclosure without departing from the spirit and scope of the present disclosure as set forth in the claims, with functional equivalents thereof to be included therein.

What is claimed is:

1. A display device comprising:
a display comprising pixels connected to a first power line, to a second power line, to scan lines, and to data lines;
a current sensor for sensing a global current value flowing to the pixels;
a power generator for supplying a first driving power to the first power line, and a second driving power to the second power line; and
a timing controller for controlling the power generator so that a voltage rising time of the first driving power is changed in response to a differential voltage value corresponding to a difference between a voltage of the first driving power of a previous frame and a voltage of the first driving power of a current frame, and in response to a differential current value corresponding to a difference between the global current value and a maximum current value to flow to the pixels in response to a load of the display.

2. The display device according to claim 1, wherein the timing controller is configured to control the power generator so that the voltage of the first driving power is risen in a step-wave form in response to the differential voltage value having a value that is greater than or equal to a first threshold value and the differential current value having a value that is greater than or equal to a second threshold value.

3. The display device according to claim 1, further comprising a sensing resistor between the first power line and the display, and connected to the current sensor to enable sensing of the global current value.

4. The display device according to claim 1, wherein the timing controller comprises:
an analyzer for analyzing peak grayscale and the load on a frame basis using input data;
a voltage determiner for determining a voltage value of the first driving power on the frame basis in response to the peak grayscale and the load;
a voltage comparer for receiving the voltage of the first driving power of the previous frame and the voltage of the first driving power of the current frame from the voltage determiner to generate the differential voltage value;
a current comparer for generating the differential current value by comparing the maximum current value with the global current value;
a voltage controller for generating an enable signal based on the differential voltage value and the differential current value; and
a code value generator configured to generate a voltage code so that the voltage of the first driving power is risen stepwise in response to the enable signal.

5. The display device according to claim 4, wherein the power generator is configured to generate the first driving power in response to the voltage code.

6. The display device according to claim 4, further comprising a memory comprising:
a first lookup table for storing a threshold voltage value corresponding to the load;
a second lookup table for storing a threshold current value corresponding to the load;
a third lookup table for storing the maximum current value corresponding to the load; and
a fourth lookup table for storing time/voltage information comprising time information at which the first driving power is risen, and voltage information at which the first driving power is risen.

7. The display device according to claim 6, wherein the threshold voltage value is configured to increase as the load increases.

8. The display device according to claim 6, wherein the threshold current value is configured to increase as the load increases.

9. The display device according to claim 6, wherein the maximum current value is configured to increase as the load increases.

10. The display device according to claim 6, wherein the code value generator is configured to generate the voltage code so that the voltage of the first driving power is risen stepwise by a voltage for respective time periods in response to the enable signal.

11. The display device according to claim 6, wherein the voltage controller is configured to generate the enable signal in response to the differential voltage value exceeding the threshold voltage value corresponding to the load, and the differential current value exceeding the threshold current value corresponding to the load.

12. The display device according to claim 6, wherein the code value generator is configured to rise the voltage of the first driving power to a voltage corresponding to the current frame when the enable signal is not input.

13. A method of driving a display device comprising pixels configured to emit light in response to an amount of current flowing from a first driving power to a second driving power via a light-emitting element, the method comprising:
generating a differential voltage value between a first voltage of the first driving power of a current frame and a second voltage of the first driving power of a previous frame;
generating a differential current value between a maximum current value to flow to a display in response to a load of the display and an actual current flowing to the display; and
controlling a rising time of the first driving power in response to the differential voltage value and the differential current value.

14. The method according to claim 13, wherein the controlling of the rising time of the first driving power comprises:
comparing the differential voltage value with a threshold voltage value corresponding to the load;
comparing the differential current value with a threshold current value corresponding to the load; and
controlling a voltage of the first driving power to be risen stepwise to the first voltage in response to the differential voltage value being greater than the threshold voltage value and the differential current value being greater than the threshold current value.

15. The method according to claim 14, wherein the controlling of the rising time of the first driving power comprises rising the voltage of the first driving power to the first voltage in response to the differential voltage value being less than the threshold voltage value or the differential current value being less than the threshold current value.

16. The method according to claim 14, further comprising increasing the threshold voltage value as the load increases.

17. The method according to claim 14, further comprising increasing the threshold current value as the load increases.

18. The method according to claim 14, further comprising rising the voltage of the first driving power stepwise such that the voltage of the first driving power rises by a voltage amount at respective time periods.

19. An electronic device comprising:
a display panel comprising pixels configured to receive a driving current from a first driving power;
a voltage generation circuit configured to generate the first driving power; and
a controller configured to control a rising time of the first driving power in response to a differential voltage value corresponding to a difference between a voltage of the first driving power of a current frame and a voltage of the first driving power of a previous frame and in response to a differential current value corresponding to a difference between a maximum current value to flow to the display panel in response to a load and a current actually flowing to the display panel.

20. The electronic device according to claim 19, wherein the controller is configured to control the voltage generation circuit so that the first driving power is risen stepwise in response to the differential voltage value being greater than a first threshold value and the differential current value being greater than a second threshold value.
